(19) United States
(12) Patent Application Publication
(10) Pub. No.: US 2009/0011810 A1
(43) Pub. Date: Jan. 8, 2009

(54) Tournament System and Method of Operation Thereof

(75) Inventor: Martin Paul Moshal, Queens Way Quay (GI)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Waterleaf Limited, Douglas, IO (GB)

(21) Appl. No.: 11/587,550

(22) PCT Filed: Apr. 25, 2005
(86) PCT No.: PCT/IB2005/001105

§ 371 Date: Jul. 10, 2008

(30) Foreign Application Priority Data
Apr. 26, 2004 (GB) 0409224.3

(51) Int. Cl. A63F 13/12; A63F 9/24

(52) U.S. Cl. 463/9; 463/42; 463/43; 463/25; 463/26

(57) ABSTRACT

A tournament system (1) for conducting a multiplayer tournament, in which a plurality of players compete in a multiplayer game to determine a winner thereof, comprises a gaming server (7) and a number of Internet-enabled computer workstations (9) for conducting a number of online elimination rounds of the multiplayer game. Each online elimination round includes a plurality of online instances of the multiplayer game. The gaming server (7) is arranged to determine a winner for each online instance of the multiplayer game. The gaming server (7) also provides for conducting a plurality of successive online elimination rounds of the multiplayer game and enable only the winner of each online instance of the multiplayer game in any online elimination round to participate in an immediately succeeding online elimination round.

### FIELD OF THE INVENTION

This invention relates to a tournament system and, more particularly, to a tournament system that is operable to conduct a multiplayer tournament, more specifically a multiplayer game tournament. The invention extends to a method of operation of the tournament system and to a method of conducting a tournament.

### BACKGROUND TO THE INVENTION

Multiplayer tournaments, such as bridge tournaments are well known and widely supported in many jurisdictions.

Such multiplayer tournaments generally consist of a number of different rounds of play, starting with a qualifying round from which a number of the best players emerge and proceeded to play in subsequent rounds of the tournament. At each round of the tournament, the number of participating players is further reduced until a predetermined number of players remain, who then participate in a final round from which a winner of the tournament emerges.

Tournaments of this type have a disadvantage in that all of the rounds of the tournament must be played at the same venue or, alternatively, the qualifying rounds must be played at different predetermined venues in the form of district or regional tournaments, thus necessitating all players to be present at the respective venues, which is unnecessarily costly and logistically difficult to administer.

### OBJECT OF THE INVENTION

It is an object of this invention to provide a tournament system, a method of operation of the tournament system, and a method of conducting a tournament that will, at least partially, alleviate the abovementioned difficulties and disadvantages

### SUMMARY OF THE INVENTION

In accordance with this invention there is provided a tournament system for conducting a multiplayer tournament in which a plurality of players compete in a multiplayer game to determine a winner thereof, comprising:

online means for conducting at least one online elimination round of the multiplayer game, the at least one online elimination round including a plurality of online instances of the multiplayer game, the online means being arranged to determine a winner for each online instance of the multiplayer game; and
adjudication means for conducting at least one final round of the multiplayer game, the at least one final round consisting of a single instance of the multiplayer game in which the winner of this instance of the multiplayer game is determined as the winner of the tournament; and
broadcasting means associated with the adjudication means, the broadcasting means being operable to broadcast a video image of the progress of the at least one final round of the tournament.

Further features of the invention provide for the online means to conduct a plurality of successive online elimination rounds of the multiplayer game, each one of the plurality of online elimination rounds including a plurality of online instances of the multiplayer game, and for the online means to enable only the winner of each instance of the multiplayer game in any online elimination round to participate in an immediately succeeding online elimination round.

Still further features of the invention provide for the adjudication means to also conduct a semi-final round of the multiplayer game, the semi-final round including a plurality of instances of the multiplayer game, for the adjudication means to enable only the winner of each online instance of the multiplayer game in the last online elimination round to participate in the semi-final round, for the adjudication means to enable only the winner of each instance of the multiplayer game in the semi-final round to participate in the final round of the multiplayer game, and for the broadcasting means to be operable to also broadcast a video image of the progress of each instance of the multiplayer game in the semi-final round.

Yet further features of the invention provide for the online means to determine the finishing order of players in each online instance of every online elimination round of the multiplayer game, for the online means to award a corresponding prize to each player in the final online elimination round of the multiplayer game, the prize being inversely proportional to the finishing order of that player in the online instance of the final online elimination round, for the adjudication means to determine the finishing order of players in the semi-final and final rounds of the multiplayer game, for the adjudication means to award a corresponding prize to each player in the semi-final and final rounds of the multiplayer game, the prize being inversely proportional to the finishing order of that player in the instance of the particular semi-final or final round, and for the adjudication means to award a jackpot prize to a winner of the final round.

There is also provided for the online means to include:

a gaming server operable under program control to regulate the progress of at least one instance of the multiplayer game, the gaming server enabling participation in the at least one instance of the multiplayer game by a predetermined plurality of players;
a user access facility communicable with the gaming server by means of a communication network and being operable by the respective player to access the gaming server along the communication network;
a register of players participating in the at least one instance of the game, the register including, for at each participating player, data representative of the at least one instance of the multiplayer game in which the player is participating;
wagering means operable by each player to place a wager on the at least one instance of the multiplayer game; and
discrimination means responsive to progress of the at least one instance of the multiplayer game to determine whether a wager placed thereon by any one of the participating players is successful or unsuccessful.

There is further provided for the communication network to be the Internet, for the user access facility to be a computer workstation connectable to the World Wide Web of the Internet, and for the multiplayer game to be a game of multiplayer poker.

The invention extends to a method of operation of a tournament system for conducting a multiplayer tournament in which a plurality of players compete in a multiplayer game to determine a winner, comprising the steps of:

conducting at least one online elimination round of the multiplayer game, the at least one online elimination round including a plurality of online instances of the multiplayer game;
determining a winner for each online instance of the multiplayer game;
conducting at least one final round of the multiplayer game, consisting of a single instance of the multiplayer game in which the winner of this instance of the multiplayer game is determined as the winner of the tournament; and
broadcasting a video image of the progress of the at least one final round of the tournament.

There is further provided for conducting a plurality of successive online elimination rounds of the multiplayer game, each one of the plurality of online elimination rounds including a plurality of instances of the multiplayer game, and enabling only the winner of each online instance of the multiplayer game in any online elimination round to participate in an immediately succeeding online elimination round.

There is still further provided for the method to include the step of conducting a semi-final round of the multiplayer game, the semi-final round including a plurality of instances of the multiplayer game, for enabling only the winner of each online instance of the multiplayer game in the last online elimination round to participate in the semi-final round of the multiplayer game, for enabling only the winner of each instance of the multiplayer game in the semi-final round to participate in the final round of the multiplayer game, and for broadcasting a video image of the progress of each instance of the multiplayer game in the semi-final round.

There is yet further provided for determining the finishing order of players in each online instance of every online elimination round of the multiplayer game, for awarding a corresponding prize to each player in the final online elimination round of the multiplayer game, the prize being inversely proportional to the finishing order of that player in the instance of the final online elimination round, for determining the finishing order of players in the semi-final and final rounds of the multiplayer game, for awarding a corresponding prize to each player in the semi-final and final rounds of the multiplayer game, the prize being inversely proportional to the finishing order of that player in the instance of the particular semi-final or final round, and for awarding a jackpot prize to a winner of the final round.

The invention extends to a method of conducting a multiplayer tournament in which a plurality of players compete in a multiplayer game to determine a winner thereof, comprising the steps of:

conducting at least one online elimination round of the multiplayer game, the at least one online elimination round including a plurality of online instances of the multiplayer game;
determining a winner for each online instance of the multiplayer game;
conducting at least one final round of the multiplayer game consisting of a single instance of the multiplayer game;
determining the winner of the single instance of the multiplayer game in the final round to be the winner of the tournament; and
broadcasting a video image of the progress of the final round of the tournament.

There is further provided for conducting online a plurality of successive elimination rounds of the multiplayer game, each one of the plurality of elimination rounds including a plurality of online instances of the multiplayer game, and enabling only the winner of each online instance of the multiplayer game in any online elimination round to participate in an immediately succeeding online elimination round.

There is still further provided for the method to include the step of conducting a semi-final round of the multiplayer game, the semi-final round including a plurality of instances of the multiplayer game, for enabling only the winner of each online instance of the multiplayer game in the last online elimination round to participate in the semi-final round of the multiplayer game, for enabling only the winner of each instance of the multiplayer game in the semi-final round to participate in the final round of the multiplayer game, and for broadcasting a video image of the progress of each instance of the multiplayer game in the semi-final round.

There is further provided for determining the finishing order of players in each instance of every online elimination round of the multiplayer game, for awarding a corresponding prize to each player in the final online elimination round of the multiplayer game, the prize being inversely proportional to the finishing order of that player in the instance of the final online elimination round, for determining the finishing order of players in the semi-final and final rounds of the multiplayer game, for awarding a corresponding prize to each player in the semi-final and final rounds of the multiplayer game, the prize being inversely proportional to the finishing order of that player in the instance of the particular semi-final or final round, and for awarding a jackpot prize to the winner of the final round.

### BRIEF DESCRIPTION OF THE DRAWINGS

One embodiment of the invention is described below, by way of example only, and with reference to the abovementioned drawings, in which:

FIG. 1 is a functional representation of a tournament system according to the invention;

FIG. 2 is an online means of the tournament system of FIG. 1; and

FIG. 3 is an adjudication facility of the tournament system of FIG. 1.

### DETAILED DESCRIPTION OF THE INVENTION

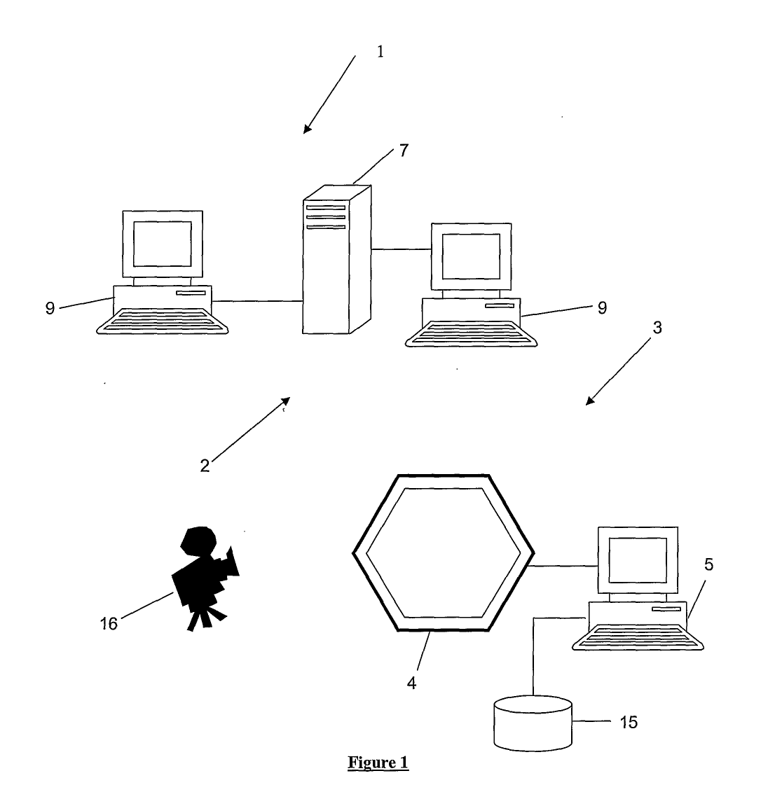

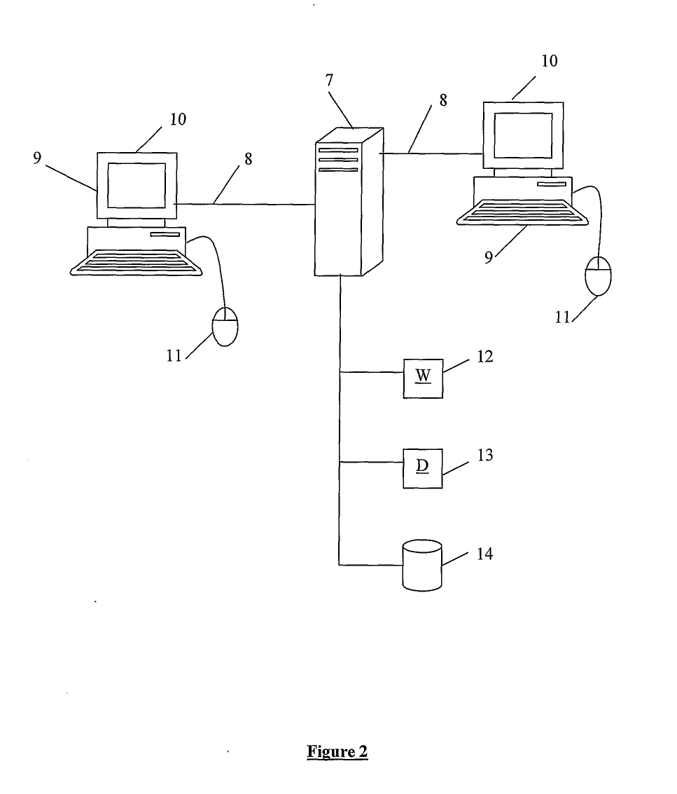

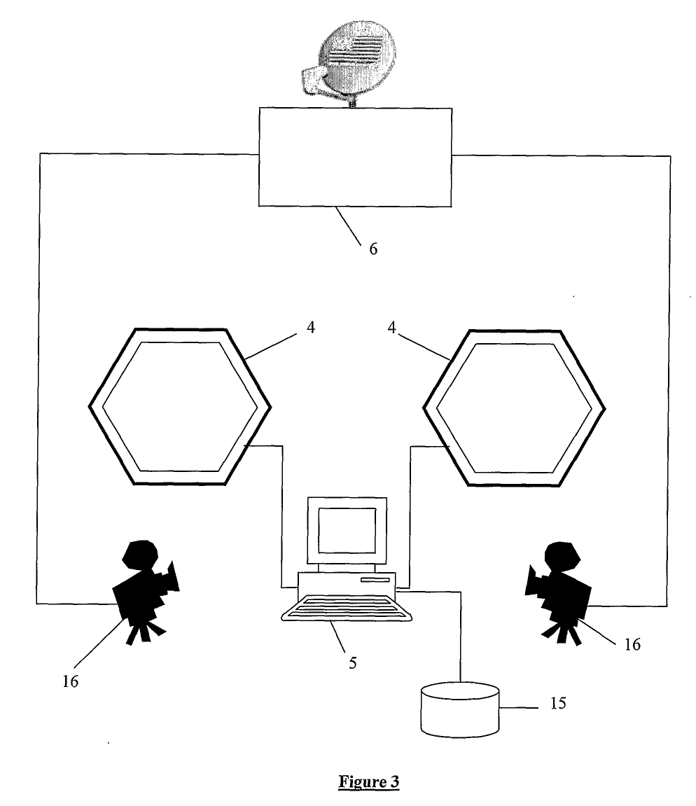

Referring to FIGS. 1 to 3, in which like features of the invention are indicated by like numerals, a tournament system for conducting a multiplayer tournament is indicated that generally by reference numeral (1). The tournament system (1) is used to conduct a multiplayer tournament in which a plurality of players compete in a multiplayer game to determine a winner thereof. In this embodiment of the invention, the multiplayer game is multiplayer poker but it is to be clearly understood that the scope of this invention is not limited to this particular multiplayer game, but extends to include other multiplayer games such as, for example, multiplayer blackjack, punto banco, baccarat or craps.

The tournament system (1) includes an online means, indicated generally by reference numeral (2), for conducting two online elimination rounds of the multiplayer poker game. Every online elimination round consists of a plurality of distinct instances of the multiplayer poker game depending on how many players participate in the tournament. Alternatively, the online means (2) may conduct three or more elimination rounds of the multiplayer poker game if this is warranted by a sufficiently large number of players wishing to participate in the tournament. For convenience, in this description, the first online elimination round of the tournament will be referred to as the preliminary round and the second online elimination round will be referred to as the satellite round.

The tournament system also includes adjudication means, indicated generally by reference numeral (3), for conducting a semi-final round and a final round of the multiplayer game. The semi-final round consists of multiple instances of the multiplayer game, while the final round consists of a single instance of the multiplayer game in which the winner of this instance of the game is determined as being the winner of the multiplayer tournament. The adjudication means (3) consists of one or more physical playing tables (4) that can be located at a predetermined venue, a supervisory computer workstation (5) and an associated broadcasting means in the form of a television broadcast unit (6) and one or more television cameras (16) that is operable to broadcast a television image of the progress of the semi-final and the final rounds of the multiplayer tournament.

The online means (2) includes a gaming server (7) connected to a communication network (8) that is, in this embodiment, the Internet. The gaming server (7) is accessible by a would-be poker player (not shown) through a user access facility (9) in the form of an Internet-enabled computer workstation having a display monitor (10) and an associated pointing device (11), such as a mouse or, alternatively, a touchpad. In this embodiment, the gaming server (7) is shown as being logically connected to two computer workstations (9). It will be appreciated by those skilled in the art of the invention that the gaming server (7) can be logically connected to any desired number of such computer workstations (9) simultaneously, which number is physically limited only by considerations of processing power and Internet access bandwidth.

The gaming server (7) operates under control of a server-stored program (not shown) capable of enabling a predetermined maximum number, say 10, of players to play an instance of the game of multiplayer poker. When the number of players reaches this predetermined maximum number, the server-stored program causes a further instance of the game to be initiated, the new instance of the game also being capable of accommodating a further 10 players. In this manner, the gaming server (7) is capable, under server-stored program control, of spawning as many separate instances of the game of multiplayer poker as required in order to accommodate the pool of players who desired to participate in the tournament, in groups of a maximum of 10. Each instance of the game of multiplayer poker spawned in this manner is treated as totally independent of the other instances of the multiplayer game.

The gaming server (7) enables a player who desires to join the tournament to request, by means of one of the computer workstations (9) participation in the tournament and, once admitted to an instance of the game in the preliminary round, to place a wager on the turn of that instance of the game. Each participating player is presented with an identical graphical user interface (GUI) on his respective computer workstation (9) by a separate workstation-stored program (not shown) in the workstation. The GUI presents to the player a suitable display of a poker game (not shown) with appropriate activatable icons that enable the player to make his own desired game play decisions and to monitor the progress of the multiplayer poker game by viewing the game play decisions of the other participating players in the same instance of the multiplayer game.

The server-stored program also provides a wagering means (12) operable by any participating player to place a wager on the turn of the game, as well as discrimination means (13) capable of determining whether any wager placed by any one of the participating players on the turn of the instance of the game of multiplayer poker is successful or unsuccessful. The stored program in the gaming server (7) also maintains a dynamic register (14) of all players admitted to, and actively participating in, all the spawned instances of the multiplayer poker game, together with data identifying the particular instance of the multiplayer poker game in which each player is participating. The gaming server (7) also settles the wagers of the participating players after the completion of every turn of any instance of the multiplayer poker game.

Each computer workstation (9) is a conventional personal computer operating under a Windows 2000 operating system, which is well-known and commercially available from the Microsoft Corporation of Seattle, Wash., USA. The gaming server (7) operates under the Windows NT operating system that is also available from the Microsoft Corporation. The game of multiplayer poker consists of the workstation-stored program (not shown) referred to, for convenience, as a client process that is executable on a computer workstation (9), and the corresponding server-stored program (not shown), or server process, that is executable on the gaming server (7). The server process (not shown) generates one or more random events that affect the outcome of the game of multiplayer poker, such as the dealing of cards to participating players. The client process (not shown) obtains the result of the random events from the gaming server (7), across the communication network (8) and displays the outcome of the game on the display monitor (10) in an intelligible manner. In order to play the game of multiplayer poker from any computer workstation (9), the client process (not shown) must first be downloaded from the gaming server (7) to that computer workstation.

In use, a player wishing to participate in the multiplayer poker tournament uses a computer workstation (9) to access the gaming server (7). The player is presented with an icon (not shown) on the display monitor (10) of the computer workstation (9), which the user can activate in order to request participation in the poker tournament and to register for it. The user's request for participation is submitted to the gaming server (7), which adjudicates and processes the request in the following manner:
1. If all existing instances of the poker game are currently being played by 10 players, the existing instances of the game are all fully occupied and the request in player cannot be admitted to any instance of the game. The user is notified of the situation and added to the list of would-be players.
2. When the waiting list has grown to 10 would-be players, the gaming server (7) spawns a new instance of the game to accommodate the players in the waiting list, and the list is flushed.
3. When the gaming server (7) spawns a new instance of the poker, each participating player is assigned a predetermined quantity of credit as a stake with which to play the game.
4. The gaming server (7) may only spawn a predetermined maximum number, namely 360, of separate instances of the poker game for purposes of the tournament. The gaming server (7) advises any player wishing to participate in the tournament once this number of instances has been spawned that the tournament is fully subscribed and is closed. Such player will be required to wait until a subsequent poker tournament is established and opened by the gaming server (7).

It will be appreciated by those skilled in the art that, in the embodiment described above, separate instances of the poker game are launched asynchronously by the gaming server (7) as and when necessitated by player demand. In a variation of this embodiment, player registration can take place asynchronously according to player demand, and the gaming server (7) could spawn all 360 instances of the game simultaneously at an appointed date and time once the poker tournament has become fully subscribed. In this variation, registered players would be issued with user names and passwords and would be required to log in to the gaming server (7) by means of respective computer workstations (9) at the appointed date and time.

In each instance of the poker game, repeated turns of the game are played until a winner is determined. Any player who loses his entire stake at any time during the repeated turns of the game is eliminated from the instance of the game, and hence from the tournament. The gaming server (7) records an order in which the participating players are eliminated from each instance of the game. The gaming server (7) determines the winner of any instance of the poker game as that player who survives when all other players are eliminated from that instance of the game by losing their respective stakes.

The winners of each of the 360 different instances of the game in the preliminary round progress to, and are admitted to, to the satellite round of the tournament. The satellite round consists of 36 separate instances of the game, each accommodating 10 winning players from the preliminary round. The satellite round is played online in a similar manner to that of the preliminary round. The gaming server (7) spawns the 36 separate instances of the game at an appointed time and date and allows the winning players from the previous round to log in from their respective computer workstations (9) by means of respective user names and passwords. As in the preceding round of the tournament, the gaming server (7) records an order in which participating players are eliminated from each instance of the poker game in the satellite round, and determines the winner of each instance to be that participating player who survives when all the other participating players are eliminated from that instance of the game by losing their respective stakes.

The winners of each of the 36 different instances of the game in the satellite round progress to a semi-final round of the tournament. Prizes are awarded to all participating players in each instance of the game in the satellite round as a function of their respective finishing positions, as illustrated in the following table:

| Result (Satellite) | Prize |
|---|---|
| 1^{st} | $1000 |
| 2^{nd} | $500 |
| 3^{rd} | $300 |
| 4^{th} | $200 |
| 5^{th} | $100 |
| 6^{th}-10^{th} | $50 |

The semi-final round of the tournament is held at a predetermined land-based venue at which all 36 players who have qualified appear in person. The semi-final round is arranged as six separate table games, each taking place at a physical playing table (4) that accommodates six players. As with the online elimination rounds of the tournament, each player is provided with an equal stake in order to participate.

The supervisory computer workstation (5) contains a register (15) in the form of a database of all 36 players participating in the semi-final round of the tournament. The supervisory computer workstation (5) is operable by an operator of the tournament, from time to time, to update each player's status in the tournament. In particular, the register (15) is updated whenever a player loses his stake to indicate that the player has been eliminated from the tournament. The supervisory computer workstation (5) derives, from the register (15), an order in which the participating players are eliminated from each one of the physical playing tables (4).

In contradistinction with the preliminary and satellite rounds of the tournament, which are conducted online, and are thus not generally visible, television coverage of the semi-final round is provided. The television broadcast unit (6) and the television cameras (16) that are present at the land-based venue provide live coverage of the round. Live coverage of sporting and other events is commonplace in the art and will not, for this reason, be discussed here in detail.

The winners of each of the six table games in the semi-final round of the tournament qualify for a final round, while prizes are awarded to players according to their respective finishing positions at the various tables, as follows:

| Result (Semi-final) | Prize |
|---|---|
| 1^{st} | $10,000 |
| 2^{nd} | $10,000 |
| 3^{rd} | $7,500 |
| 4^{th} | $6,000 |
| 5^{th} | $4500 |
| 6^{th} | $2500 |

The final round of the tournament is also held at a land-based venue, which may be the same venue as that of the semi-final round, or a different venue altogether. All six qualifiers from the semi-final round appear in person and compete at a single table and are each provided with an equal stake in order to participate. As with the semi-final round, live coverage of the final round is provided by means of the television broadcast unit (6).

The winner of the final round is the overall winner of the tournament, and prizes are awarded to the remaining players according to the finishing positions at the table, as per the following prize table:

| Result (Final) | Prize |
|---|---|
| 1^{st} | $100,000 |
| 2^{nd} | $50,000 |
| 3^{rd} | $30,000 |
| 4^{th} | $20,000 |
| 5^{th} | $10,000 |
| 6^{th} | $5,000 |

It is envisaged that an operator of the poker tournament will derive revenue from several different streams such as, for example:
1. fees from television broadcasters for rights to broadcast live coverage of the semi-final and final rounds of the tournament;
2. fees from online networks for rights to host the online rounds of the tournament;
3. advertising revenue; and
4. sponsorship income.

Numerous modifications are possible to this embodiment without departing from the scope of the invention. For example, the system (1) may be applied to any multiplayer game on which participating players may place wagers. Further examples of such games are backgammon, bridge, gin rummy, canasta, whist or mah-jong. Further, the tournament may be increased in size to accommodate a greater number of players than that described in this embodiment. Where the tournament accommodates more players than described above, it may be necessary to increase the number of online rounds and the number of “live” rounds of the tournament relative to the two online rounds and to live rounds described in this embodiment.

The technical problem solved by this invention is to enable implementation of a distributed multiplayer tournament, based on multiplayer games such as those listed above, that draws players from different geographical locations, without the need for conducting district and regional competitions to determine progress of successful participants to later stages of the tournament. The invention can spawn online instances of the multiplayer game asynchronously as sufficient players enter and register for the tournament. Any player who was unsuccessful in a first round of the tournament is permitted to re-enter and re-register for a second or subsequent attempt in the tournament.

The invention therefore provides a flexible system for conducting rapid multiplayer tournaments that can accommodate players from different locations and jurisdictions, and that is both convenient for player participation and attractive to sponsors and advertisers because of broadcast publicity.

1. A tournament system for conducting a multiplayer tournament in which a plurality of players compete in a multiplayer game to determine a winner thereof, comprising:
online means for conducting at least one online elimination round of the multiplayer game, the at least one online elimination round including a plurality of online instances of the multiplayer game, the online means being arranged to determine a winner for each online instance of the multiplayer game;
adjudication means for conducting at least one final round of the multiplayer game, the at least one final round consisting of a single instance of the multiplayer game in which the winner of this instance of the multiplayer game is determined as the winner of the tournament; and broadcasting means associated with the adjudication means, the broadcasting means being operable to broadcast a video image of the progress of the at least one final round of the tournament.

2. A tournament system as claimed in claim 1 in which online means conducts a plurality of successive online elimination rounds of the multiplayer game, each one of the plurality of online elimination rounds including a plurality of online instances of the multiplayer game.

3. A tournament system as claimed in claim 2 in which the online means enables only the winner of each online instance of the multiplayer game in any online elimination round to participate in an immediately succeeding online elimination round.

4. A tournament system as claimed in claim 3 in which the adjudication means also conducts a semi-final round of the multiplayer game, the semifinal round including a plurality of instances of the multiplayer game.

5. A tournament system as claimed in claim 4 in which the adjudication means enables only the winner of each online instance of the multiplayer game in the last online elimination round to participate in the semi-final round.

6. A tournament system as claimed in claim 5 in which the adjudication means enables only the winner of each instance of the multiplayer game in the semi-final round to participate in the final round of the multiplayer game.

7. A tournament system as claimed in claim 6 in which the broadcasting means is operable to also broadcast a video image of the progress of each instance of the multiplayer game in the semi-final round.

8. A tournament system as claimed in claim 7 in which the online means determines the finishing order of players in each online instance of every online elimination round of the multiplayer game.

9. A tournament system as claimed in claim 8 in which the online means awards a corresponding prize to each player in the final online elimination round of the multiplayer game, the prize being inversely proportional to the finishing order of that player in the online instance of the final online elimination round.

10. A tournament system as claimed in claim 9 in which the adjudication means determines the finishing order of players in the semi-final and final rounds of the multiplayer game.

11. A tournament system as claimed in claim 10 in which the adjudication means awards a corresponding prize to each player in the semi-final and final rounds of the multiplayer game, the prize being inversely proportional to the finishing order of that player in the instance of the particular semi-final or final round.

12. A tournament system as claimed in claim 11 in which the adjudication means awards a jackpot prize to a winner of the final round.

13. A tournament system as claimed in claim 1 in which the online means includes:
a gaming server operable under program control to regulate the progress of at least one instance of the multiplayer game, the gaming server enabling participation in the at least one instance of the multiplayer game by a predetermined plurality of players;
a user access facility communicable with the gaming server by means of a communication network and being operable by the respective player to access the gaming server along the communication network;
a register of players participating in the at least one instance of the game, the register including, for at each participating player, data representative of the at least one instance of the multiplayer game in which the player is participating;
wagering means operable by each player to place a wager on the at least one instance of the multiplayer game; and
discrimination means responsive to progress of the at least one instance of the multiplayer game to determine whether a wager placed thereon by any one of the participating players is successful or unsuccessful.

14. A tournament system as claimed in claim 13 in which the communication network is the Internet.

15. A tournament system as claimed in claim 14 in which the user access facility is a computer workstation connectable to the World Wide Web of the Internet.

16. A tournament system as claimed in claim 1 in which the multiplayer game is a game of multiplayer poker.

17. A method of operation of a tournament system for conducting a multiplayer tournament in which a plurality of players compete in a multiplayer game to determine a winner thereof, comprising the steps of:
conducting at least one online elimination round of the multiplayer game, the at least one online elimination round including a plurality of online instances of the multiplayer game;
determining a winner of each online instance of the multiplayer game;
conducting at least one final round of the multiplayer game consisting of a single instance of the multiplayer game;
determining the winner of the single instance of the multiplayer game in the final round to be the winner of the tournament; and
broadcasting a video image of the progress of the final round of the tournament.

18. A method as claimed in claim 17 in which a plurality of successive online elimination rounds of the multiplayer game are conducted, each one of the plurality of online elimination rounds including a plurality of online instances of the multiplayer game.

19. A method as claimed in claim 18 which includes a step of enabling only the winner of each online instance of the multiplayer game in any online elimination round to participate in an immediately succeeding online elimination round.

20. A method as claimed in claim 19 which includes the further step of conducting a semi-final round of the multiplayer game, the semi-final round including a plurality of instances of the multiplayer game.

21. A method as claimed in claim 20 in which only the winner of each online instance of the multiplayer game in the last online elimination round is enabled to participate in the semi-final round of the multiplayer game.

22. A method as claimed in claim 21 in which only the winner of each instance of the multiplayer game in the semi-final round is enabled to participate in the final round of the multiplayer game.

23. A method as claimed in claim 22 that includes a step of broadcasting a video image of the progress of each instance of the multiplayer game in the semi-final round.

24. A method as claimed in claim 23 in which the finishing order of players in each online instance of every online elimination round of the multiplayer game is determined.

25. A method as claimed in claim 24 in which a corresponding prize is awarded to each player in the final online elimination round of the multiplayer game, the prize being inversely proportional to the finishing order of that player in the instance of the final online elimination round.

26. A method as claimed in claim 25 in which the finishing order of players in the semi-final and final rounds of the multiplayer game is determined.

27. A method as claimed in claim 26 in which a corresponding prize is awarded to each player in the semi-final and final rounds of the multiplayer game, the prize being inversely proportional to the finishing order of that player in the instance of the particular semi-final or final round.

28. A method as claimed in claim 27 in which a jackpot prize is awarded to a winner of the final round.

29. A method of conducting a multiplayer tournament in which a plurality of players compete in a multiplayer game to determine a winner thereof, comprising the steps of:
conducting at least one online elimination round of the multiplayer game, the at least one elimination round including a plurality of online instances of the multiplayer game;
determining a winner for each online instance of the multiplayer game;
conducting at least one final round of the multiplayer game consisting of a single instance of the multiplayer game;
determining the winner of the single instance of the multiplayer game in the final round as the winner of the tournament; and
broadcasting a video image of the progress of the final round of the tournament.

30. A method as claimed in claim 29 in which a plurality of successive online elimination rounds of the multiplayer game are conducted, each one of the plurality of online elimination rounds including a plurality of online instances of the multiplayer game.

31. A method as claimed in claim 30 which includes a step of enabling only the winner of each online instance of the multiplayer game in any elimination round to participate in an immediately succeeding online elimination round.

32. A method as claimed in claim 31 which includes a further step of conducting a semi-final round of the multiplayer game, the semi-final round including a plurality of instances of the multiplayer game.

33. A method as claimed in claim 32 in which only the winner of each online instance of the multiplayer game in the last online elimination round is enabled to participate in the semi-final round of the multiplayer game.

34. A method as claimed in claim 33 in which only the winner of each instance of the multiplayer game in the semi-final round is enabled to participate in the final round of the multiplayer game.

35. A method as claimed in claim 34 that includes a step of broadcasting a video image of the progress of each instance of the multiplayer game in the semi-final round.

36. A method as claimed in claim 35 in which the finishing order of players in each instance of every online elimination round of the multiplayer game is determined.

37. A method as claimed in claim 36 in which a corresponding prize is awarded to each player in the final online elimination round of the multiplayer game, the prize being inversely proportional to the finishing order of that player in the instance of the final online elimination round.

38. A method as claimed in claim 37 in which the finishing order of players in the semi-final and final rounds of the multiplayer game is determined.

39. A method as claimed in claim 38 in which a corresponding prize is awarded to each player in the semi-final and final rounds of the multiplayer game, the prize being inversely proportional to the finishing order of that player in the instance of the particular semi-final or final round.

40. A method as claimed in claim 39 in which a jackpot prize is awarded to the winner of the final round.
